(19) United States
(12) Patent Application Publication
(10) Pub. No.: US 2005/0263984 A1
(43) Pub. Date: Dec. 1, 2005

(54) Trailer hitch device

(76) Inventor: Wendall A. Gurtler, Iowa Falls, IA (US)

Correspondence Address: STURM & FIX LLP, 206 SIXTH AVENUE, SUITE 1213, DES MOINES, IA, 50309-4076, US

(21) Appl. No.: 10/853,948

(22) Filed: May 26, 2004

(51) Int. Cl. B60D 1/00

(52) U.S. Cl. 280/489

(57) ABSTRACT

The present invention is directed toward a trailer hitch assembly that includes a pair of brackets secured to a vehicle frame in parallel spaced relation and a pair of arms secured to the brackets. A torsion bar is provided that extends between and is secured to the arms. Additionally, a receiver is provided that extends outwardly from the torsion bar and has an opening for receiving a draw bar for a hitch. In another embodiment, the trailer hitch assembly is adapted for use with a conventional trailer hitch mounted to a vehicle and includes a draw bar adapted to be inserted within the receiver of the conventional trailer hitch.

### BACKGROUND OF THE INVENTION

The present invention relates to a trailer hitch and, more specifically, a trailer hitch that prevents vibration and other erratic motion from the trailer from transferring to the vehicle during travel.

Wheeled trailers are frequently towed behind vehicles to transport various items including boats, campers, horses, and other cargo. Many types of hitches have been developed to receive and tow a wheeled trailer.

A disadvantage of conventional trailer hitches is that uneven road surfaces cause vibration resulting in wear and damage to the trailer hitch. Additionally, the vibration and erratic motion from the trailer tends to transfer through the hitch to the vehicle, thereby affecting the vehicle's performance. This problem is only exaggerated when the trailer is empty or hauling a light load. When the trailer is unloaded, bumps in the road will cause the trailer to pitch and move in an erratic fashion, pulling the vehicle from side to side.

Many trailers have been developed that include shock absorbers and other dampening devices for reducing the vibration and erratic motion of the trailer, particularly when the trailer is unloaded. One such example is U.S. Pat. No. 5,887,884 to Smith, which teaches a trailer having a shock absorber. The disadvantage with trailers such as the Smith apparatus is that a consumer must upgrade any conventional trailers to include the shock absorbers taught by Smith. This can be costly, particularly if the consumer has multiple trailers for towing different types of cargo.

U.S. Pat. No. 5,823,560 to Van Vleet addresses the vibration problem by modifying the actual trailer hitch. In this manner, any trailer secured to the Van Vleet device will receive the cushioning effects of the Van Vleet device. The disadvantage with the Van Vleet device is that it requires the use of a complex ball hitch assembly, which is comprised of rigid steel parts. As such, the Van Vleet device provides very limited movement and shock dampening capabilities. Accordingly, there is a need in the art for an improved trailer hitch.

It is therefore a principal object of this invention to provide a trailer hitch that absorbs shock and vibrations from any type of trailer, particularly when the trailer is unloaded.

Another object of this invention is to provide a trailer that improves the ride of the towing vehicle by preventing vibration from transferring through the trailer hitch to the vehicle.

A further object of this invention is to provide a trailer hitch with a torsion bar that absorbs vibration and other erratic forces from the trailer.

These and other objects will be apparent to those skilled in the art.

### BRIEF SUMMARY OF THE INVENTION

The present invention is directed toward a trailer hitch assembly. In one embodiment, the trailer hitch assembly includes a pair of brackets secured to a vehicle frame in parallel spaced relation and a pair of arms secured to the brackets. A torsion bar is provided that extends between and is secured to the arms. Additionally, a receiver is provided that secures to and extends outwardly from the torsion bar and has an opening for receiving a draw bar for a hitch.

In another embodiment, the trailer hitch assembly is adapted for use with a conventional trailer hitch mounted to a vehicle and includes a draw bar adapted to be inserted within the receiver of the conventional trailer hitch. A center bracket is provided that secures to the draw bar and receives and retains a torsion bar received by an opening in and secured to the center bracket. A second receiver is provided that secures to and extends outwardly from the torsion bar and has an opening for receiving a second draw bar for a hitch.

In still other embodiments, the trailer hitch assembly is adapted for use with trailers with no tongue weight or with a steering axle. In these embodiments, a lowered ball hitch is provided for receiving and towing the trailer.

### BRIEF DESCRIPTION OF THE DRAWINGS

FIG. 1 is a perspective view of an embodiment of the trailer hitch assembly of the present invention;

FIG. 1A is an exploded view of the trailer hitch assembly of FIG. 1;

FIG. 2 is a front view of an embodiment of the trailer hitch assembly of the present invention;

FIG. 3 is a side view of an embodiment of the trailer hitch assembly of the present invention;

FIG. 4A is a cross sectional view of the torsion bar of the present invention;

FIG. 4B is a cross sectional view of another embodiment of the torsion bar of the present invention;

FIG. 5 is a perspective view of another embodiment of the trailer hitch assembly of the present invention;

FIG. 6 is a perspective view of another embodiment of the trailer hitch assembly of the present invention; and

FIG. 7 is a perspective view of another embodiment of the trailer hitch assembly of the present invention.

### DESCRIPTION OF THE PREFERRED EMBODIMENTS OF THE INVENTION

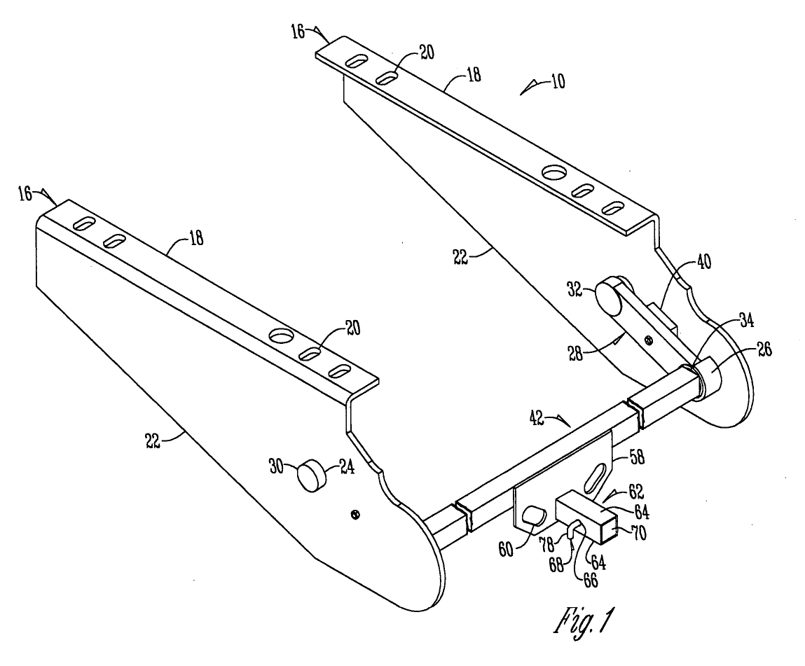

With reference to FIGS. 1-3, a trailer hitch assembly 10 is disclosed for mounting to the frame 12 of a vehicle 14. Trailer hitch assembly 10 includes a pair of oppositely facing brackets 16 that mount to the vehicle frame 12 in parallel spaced relation. Preferably, the brackets 16 are positioned longitudinally along the frame 12 at the rear end of the vehicle 14. Brackets 16 include a flange portion 18 with openings 20 for securing the brackets 16 to the vehicle frame 12 via fasteners such as bolts (not shown). Alternatively, the flange portion 18 may be welded to the vehicle frame 12 or attached in any other conventional manner. Brackets 16 also include vertical side portions 22. Side portion 22 has an opening 24 and a U-shaped cradling member 26, as discussed hereafter.

A pair of arms 28 secure to the brackets 16. Arm 28 includes a support bar 30 at end 32 which passes through the opening 24 in the side 22 of brackets 16. Arm 28 also includes a circular recess 34, as discussed hereafter, at opposite end 36 that faces in a direction opposite the side 22 of bracket 16. End 36 of arm 28 fits within cradling member 26 of bracket 16 such that arm 28 is positioned downward and diagonally with respect to side 22 of bracket 16. Arm 28 is secured to bracket 16 via a bolt or fastener 38, which passes through the center of arm 28 between ends 32 and 36. Additionally, fastener 38 retains a spacer 40, which is positioned between arm 28 and the side 22 of bracket 16 to maintain proper spacing of the arm 28 with respect to the bracket 16. Those skilled in the art will appreciate that there are many other ways of mounting the arms 28 to the brackets 16.

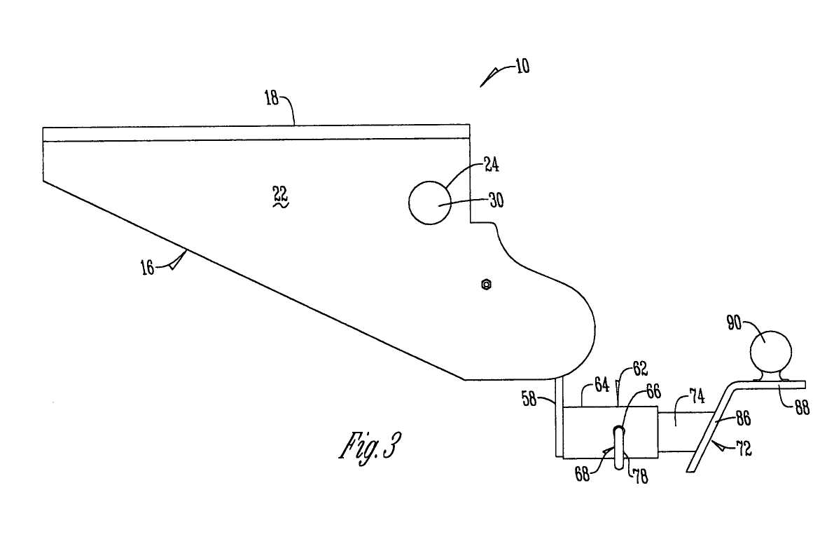

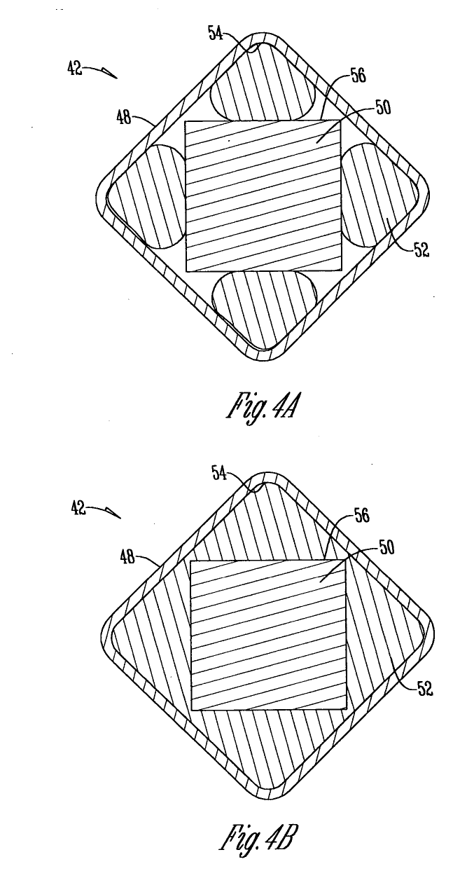

A torsion bar 42 extends between the pair of arms 28. Specifically, ends 44 and 46 of torsion bar 42 fit within the circular recesses 34 of arms 28. Torsion bar 42 comprises a metallic housing 48, which has a generally rectangular cross section, as shown in FIGS. 4A and 4B. Housing 48 contains a metallic center member 50 and resilient cushioning material 52. Center member 50 has a generally rectangular cross section and is offset approximately 45° with respect to the housing 48, as shown in FIGS. 4A and 4B. Resilient cushioning material 52, which preferably comprises rubber, is positioned in the spacing between center member 50 and housing 48. Preferably, resilient cushioning material 52 comprises four pieces of a generally circular cross section, as shown in FIG. 4A, that are compressed to fill the space between the corners 54 of housing 48 and the sides 56 of center member 50. Alternatively, resilient cushioning material 52 is of one piece that surrounds center member 50 to completely fill the space between center member 50 and housing 48, as shown in FIG. 4B. In these arrangements, the resilient cushioning material 52 works to maintain the positioning of the center member 50 within housing 48 shown in FIGS. 4A and 4B. During operation, as more fully explained hereafter, the housing 48 rotates slightly with respect to center member 50, thereby compressing the resilient cushioning material 52. Because of its properties, the resilient cushioning material 52 works to counteract the slight rotation of the housing 48 and return the housing 48 and center member 50 to their proper positioning.

A brace plate 58 is secured to the center of the torsion bar 42. As shown in FIG. 1, brace plate 58 is preferably hexagonal in shape and includes a pair of openings 60 on opposite sides of the brace plate 58. Openings 60 permit chains (not shown) and other hardware from a trailer to be secured to the trailer hitch assembly 10.

A receiver 62 is secured to the center of the brace plate 58 and extends outwardly and transversely from the torsion bar 42. The receiver 62 has a hollow tubular portion 64 with an aperture 66 on the side for receiving a pin 68, as discussed hereafter. The tubular portion 64 terminates in an opening 70, which is adapted to receive a hitch 72.

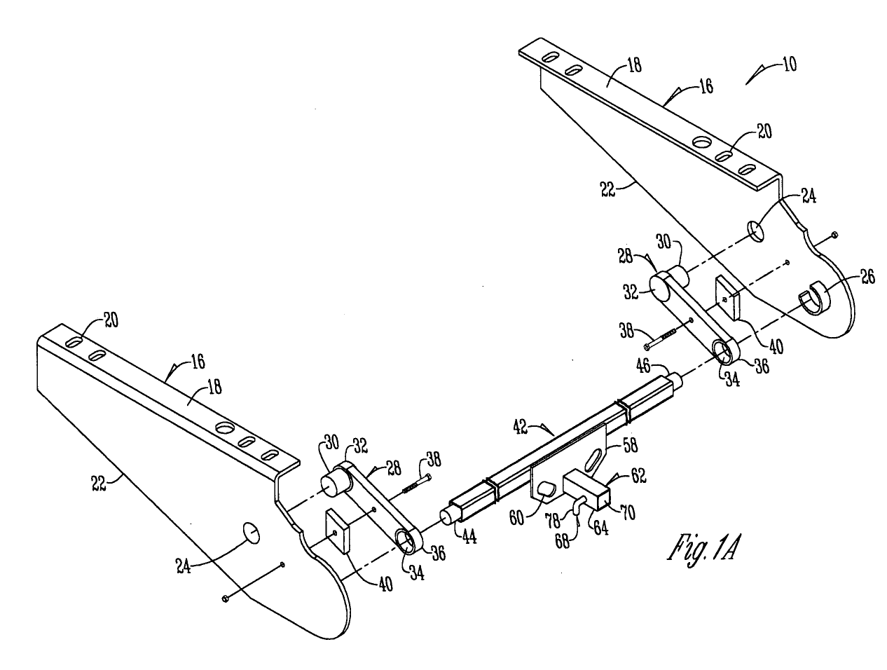

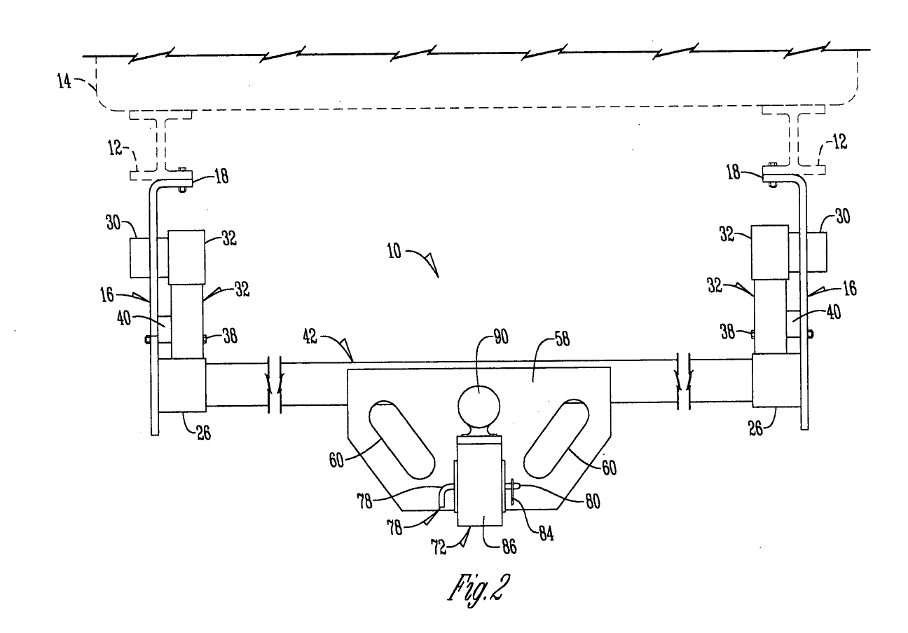

Hitch 72, as shown in FIGS. 2 and 3, includes a draw bar 74, which is tubular and inserts into receiver 62. A bore (not shown) extends transversely through draw bar 74 and aligns with aperture 66 in the receiver 62 when the draw bar 74 is properly inserted into the receiver 62. In this manner, the pin 68 engages with the aperture 66 in the receiver 62 and the bore in the draw bar 74 to secure the draw bar 74 to the receiver 62.

Pin 68 includes a handle 78 and an elongated rod 80. The elongated rod 80 has an aperture (not shown) for receiving a cotter pin 84 or similar fastener. When the pin 68 is fully engaged with the receiver 62 and the draw bar 74, the elongated rod 80 protrudes from the receiver 62, allowing for the cotter pin 84 to be inserted into aperture. As such, the cotter pin 84 prevents the pin 68 from withdrawing from aperture 66 and decoupling draw bar 74 from receiver 62.

Hitch 72 further includes a ball plate 86 secured to the draw bar 74. As shown in FIG. 1, the ball plate 86 preferably extends upwardly and outwardly from the draw bar 74. Ball plate 86 includes a threaded aperture 88 for receiving a ball hitch 90, which is adapted to receive a trailer or similar device to be towed by the trailer hitch assembly 10.

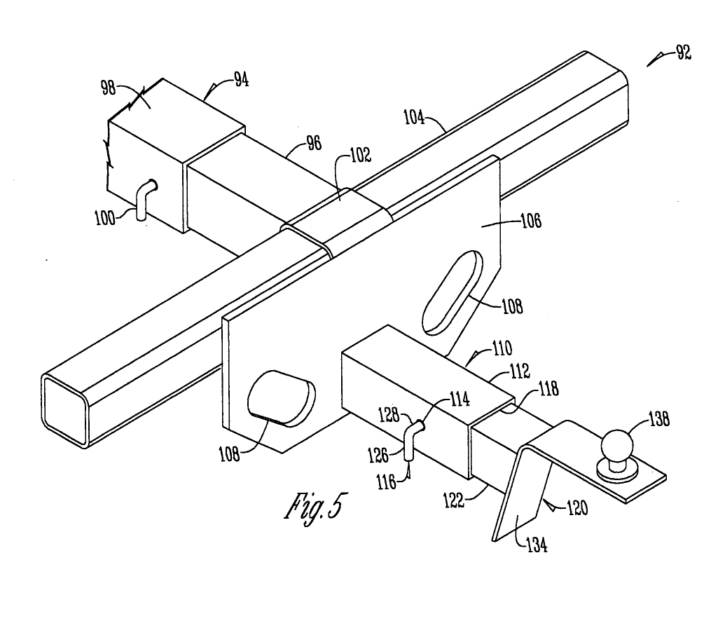

With reference to FIG. 5, a second embodiment of the trailer hitch assembly 92 is shown, which is adapted for use with a vehicle having a conventional trailer hitch 94. Trailer hitch 92 includes a first draw bar 96 that inserts into the receiver 98 of the conventional hitch 94. First draw bar 96 is secured to the receiver 98 via a pin 100.

A center bracket 102 secures to the first draw bar 96. Center bracket 102 has a generally circular cross section and is adapted to receive a torsion bar 104.

Torsion bar 104 passes through and is retained by the center bracket 102. Torsion bar 104 has the same cross section as torsion bar 42. Specifically, torsion bar 104 has a housing 48 that contains a metallic center member 50 and a resilient cushioning material 52, as shown in FIGS. 4A and 4B. As with torsion bar 42, torsion bar 104 rotates slightly, thereby compressing the resilient cushioning material 52 to counteract vibration and other undesired forces from the trailer.

A brace plate 106 is secured to the torsion bar 104. As shown in FIG. 5, brace plate 106 is preferably hexagonal in shape and includes a pair of openings 108 on opposite sides of the brace plate 106 for securing chains and other hardware, similar to brace plate 58.

A second receiver 110 is secured to the center of the brace plate 106 and extends outwardly and transversely from the torsion bar 104. The receiver 110 has a hollow tubular portion 112 with an aperture 114 on the side for receiving a pin 116, as discussed hereafter. The tubular portion 112 terminates in an opening 118, which is adapted to receive a hitch 120.

Hitch 120, as shown in FIG. 5, is substantially the same as hitch 72 and includes a second draw bar 122 that is tubular and inserts into second receiver 110. A bore (not shown) extends transversely through the draw bar 122 and aligns with aperture 114 in the receiver 110. In this manner, the pin 116 engages with the aperture 114 in the receiver 110 and the bore in the draw bar 122 to secure the draw bar 122 to the receiver 110.

Pin 116 is substantially the same as pin 68 and includes a handle 126 and an elongated rod 128. The elongated rod 128 has an aperture (not shown) for receiving a cotter pin 132 or similar fastener. When the pin 116 is fully engaged with the receiver 110 and the draw bar 122, the elongated rod 128 protrudes from the receiver 110, allowing for the cotter pin 132 to be inserted into aperture. As such, the cotter pin 132 prevents the pin 116 from withdrawing from aperture 130 and decoupling draw bar 122 from receiver 110.

Hitch 120 further includes a ball plate 134 substantially the same as ball plate 86 and secured to the second draw bar 122. The ball plate 134 preferably extends upwardly and outwardly from the draw bar 122. Ball plate 134 includes a threaded aperture (not shown) for receiving a ball hitch 138, which is adapted to receive a trailer or similar device to be towed by the trailer hitch assembly 92.

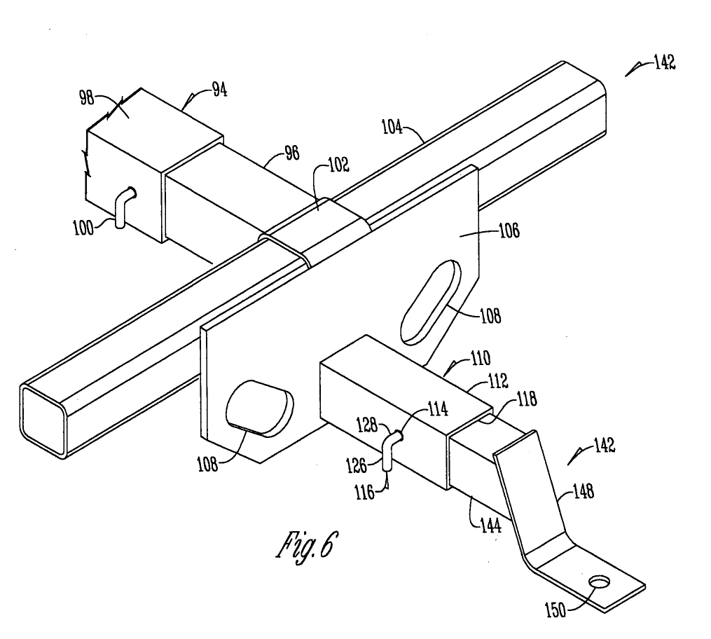

With reference to FIG. 6, a third embodiment of the trailer hitch assembly 140 is shown, which includes a first draw bar 96, center bracket 102, torsion bar 104, brace plate 106, second receiver 110, and pin 116 similar to the second embodiment of trailer hitch assembly 92. The third embodiment of the trailer hitch assembly 140 differs in that it is adapted for use with an alternative hitch 142, as shown in FIG. 6.

Hitch 142 includes a second draw bar 144, which is tubular and inserts into second receiver 110. A bore (not shown) extends transversely through the draw bar 144 and aligns with aperture 114 in the receiver 110. In this manner, the pin 116 engages with the aperture 114 in the receiver 110 and the bore in the draw bar 144 to secure the draw bar 144 to the receiver 110.

Hitch 142 further includes a lowered ball plate 148 secured to the second draw bar 144. As shown in FIG. 6, the lowered ball plate 148 extends downwardly and outwardly from the draw bar 144. Ball plate 148 includes a threaded aperture 150 for receiving a ball hitch (not shown) or similar device adapted to receive a trailer.

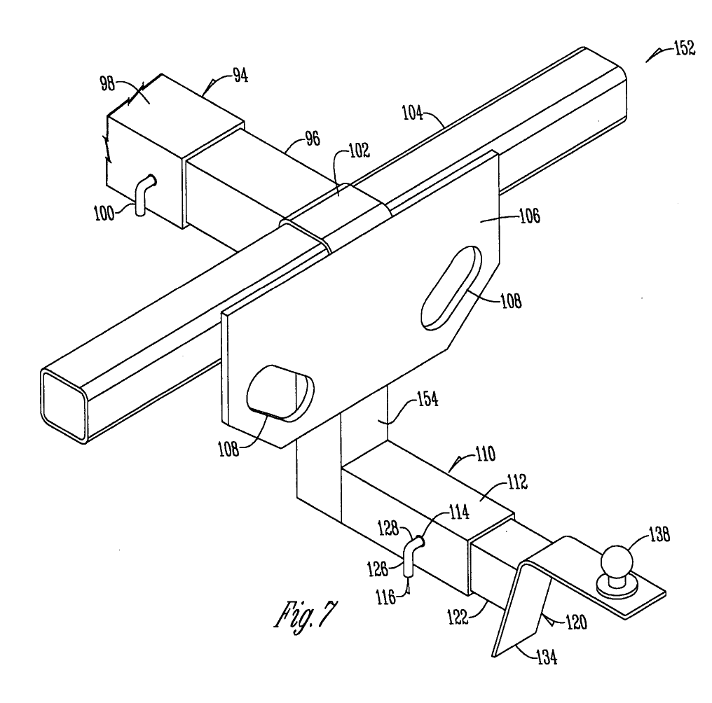

With reference to FIG. 7, a fourth embodiment of the trailer hitch assembly 152 is shown, which includes a first draw bar 96, center bracket 102, torsion bar 104, brace plate 106, second receiver 110, pin 116, second draw bar 122, ball plate 134, and ball hitch 138 similar to the second embodiment of trailer hitch assembly 92. The fourth embodiment of the trailer hitch assembly 152 differs in that the second receiver 110 is not connected directly to the brace plate 106 and torsion bar 104 like the second embodiment of the trailer hitch assembly 92. Rather, a down tube 154 is secured to the center bracket 102 and extends downwardly therefrom, as shown in FIG. 7. The second receiver 110 is secured at a right angle to the down tube 154 and extends transversely outward from the down tube 154. Second receiver 110 is adapted to receive a hitch 120 similar to the second embodiment of the trailer hitch assembly 92.

In operation, the trailer hitch assemblies 10, 92, 140, and 152 all work to dampen vibration from the trailer and prevent this erratic motion from transferring to the vehicle. Trailer hitch 10 accomplishes this function through the use of torsion bar 42. Torsion bar 42 rotates slightly, thereby compressing the resilient cushioning material 52 therein. The compression of the resilient cushioning material 52 absorbs vibration and other erratic motion from the trailer. Trailer hitch assemblies 92, 140, and 152 work in a similar manner through the use of torsion bar 104. Torsion bar 104, which includes resilient cushioning material 52 similar to torsion bar 42, absorbs vibration from the trailer and prevents this erratic motion from transferring to the vehicle.

It is therefore seen that by the use of a hitch secured to a torsion bar, this invention permits for the safe towing of a trailer by a vehicle without transferring vibration and erratic movement from the trailer to the towing vehicle.

1. A trailer hitch assembly for a vehicle having a frame, the assembly comprising:
a pair of brackets secured to the vehicle frame in parallel spaced relation;
a pair of arms secured to the brackets in parallel spaced relation;
a torsion bar extending between and secured to the arms; and
a receiver secured to and extending outwardly from the torsion bar and having an opening for receiving a draw bar for a hitch.

2. The assembly of claim 1 further comprising a ball plate extending upwardly and outwardly from the draw bar.

3. The assembly of claim 1 further comprising a ball plate extending downwardly and outwardly from the draw bar.

4. The assembly of claim 1 wherein the torsion bar comprises:
a housing;
a center member extending longitudinally within the housing; and
resilient cushioning material disposed between the center member and the housing.

5. The assembly of claim 1 further comprising a pin for removably securing the draw bar within the receiver.

6. A trailer hitch assembly adapted to be removably secured to a first receiver mounted to a vehicle, the assembly comprising:
a draw bar adapted to be inserted within the receiver;
a center bracket secured to the draw bar;
a torsion bar received by an opening in and secured to the center bracket; and
a second receiver secured to and extending outwardly from the torsion bar and having an opening for receiving a second draw bar for a hitch.

7. The assembly of claim 6 further comprising a ball plate extending upwardly and outwardly from the draw bar.

8. The assembly of claim 6 further comprising a ball plate extending downwardly and outwardly from the second draw bar.

9. The assembly of claim 6 wherein the torsion bar comprises:
a housing;
a center member extending longitudinally within the housing; and
resilient cushioning material disposed between the center member and the housing.

10. The assembly of claim 6 further comprising a pin for removably securing the second draw bar within the second receiver.

11. A trailer hitch assembly adapted to be removably secured to a first receiver mounted to a vehicle, the assembly comprising:
a draw bar adapted to be inserted within the receiver;
a center bracket secured to the draw bar;
a torsion bar received by an opening in and secured to the center bracket; and
a second receiver secured to and extending downwardly and outwardly from the center bracket and having an opening for receiving a second draw bar for a hitch.

12. The assembly of claim 11 further comprising a ball plate extending upwardly and outwardly from the draw bar.

13. The assembly of claim 11 wherein the torsion bar comprises:
a housing;
a center member extending longitudinally within the housing; and
resilient cushioning material disposed between the center member and the housing.

14. The assembly of claim 11 further comprising a pin for removably securing the second draw bar within the second receiver.
